(19) United States
(12) Patent Application Publication
(10) Pub. No.: US 2025/0131919 A1
(43) Pub. Date: Apr. 24, 2025

(54) GENERATIVE SPEECH MODEL FOR COMPACT DATA-DRIVEN SPEECH VECTORS FOR VERSATILE SPEECH APPLICATIONS

(71) Applicant: Cisco Technology, Inc., San Jose, CA (US)

(72) Inventors: Xuehong Mao, San Jose, CA (US); Samer Lutfi Hijazi, San Jose, CA (US); Christopher Rowen, Santa Cruz, CA (US); Mathew Shaji Kavalekalam, Warsaw (PL); Ivana Balic, Studen BE (CH); Mengjun Leng, San Jose, CA (US); Yusuf Ziya Isik, Edinburgh (GB); Adam Ali Sabra, Union City, CA (US); Amir Salah Abdelsamie Abdelwahed, Edinburgh (GB); Samir Ouelha, Suresnes (FR); Mihailo Kolundzija, Lausanne (CH)

(21) Appl. No.: 18/539,791

(22) Filed: Dec. 14, 2023

Related U.S. Application Data
(60) Provisional application No. 63/591,179, filed on Oct. 18, 2023.

(51) Int. Cl. G10L 15/16; G10L 15/06; G10L 15/18

(52) U.S. Cl. CPC G10L 15/16; G10L 15/063; G10L 15/1807

(57) ABSTRACT

A neural network audio codec system and related methods are provided. In one example, a method is provided comprising: obtaining speech audio to be encoded; applying the speech audio to an audio encoder that is part of a neural network audio codec system that includes the audio encoder and an audio decoder. The audio encoder and the audio decoder have been trained in an end-to-end manner. The speech audio is encoded with the audio encoder to generate embedding vectors that represent a snapshot of speech audio attributes over successive timeframes of the raw speech audio, and from the embedding vectors, codeword indices are generated to entries in a codebook. The codeword indices are then transmitted or stored for later retrieval and processing by the audio decoder.

### PRIORITY CLAIM

This application claims priority to U.S. Provisional Application No. 63/591,179, filed Oct. 18, 2023, the entirety of which is incorporated herein by reference.

### TECHNICAL FIELD

The present disclosure relates to encoding and decoding speech audio.

### BACKGROUND

Audio coding/decoding systems, commonly referred to as codecs, play a pivotal role in real-time communication technologies. One goal they have is to preserve audio content quality and intelligibility while minimizing the number of bits required for encoding the content. Furthermore, ensuring network resilience, particularly the ability to handle packet loss, is another aspect to take into account when designing codecs for real-time communications. The integration of machine learning techniques and the emergence of end-to-end neural codecs have driven advancements in bitrate reduction and improving audio quality.

In addition to encoding the audio signal, audio enhancement can play a role in real-time communication systems. Deep neural networks have shown promising results in addressing the challenges of audio enhancement in noisy and reverberant environments.

### BRIEF DESCRIPTION OF THE DRAWINGS

FIG. 1 is a system block diagram of a neural network audio codec system according to an example embodiment.

FIG. 2 is a diagram depicting end-to-end training of a neural network audio codec system according to an example embodiment.

FIG. 3 is a diagram of an automatic speech recognition system employing an audio encoder that has been trained as part of a neural network audio codec system, according to an example embodiment.

FIG. 4 is a block diagram of a speech-to-speech translation system according to an example embodiment.

FIG. 5 is a block diagram of a voice cloning and morphing system according to an example embodiment.

FIG. 6 a block diagram of a system for text-to-speech conversion with custom voice capabilities, according to an example embodiment.

FIG. 7 is a block diagram of a system that enables direct translating speech to large language model embeddings, according to an example embodiment.

FIG. 8 is a more detailed block diagram of system depicting a speech-based large language model that employs acoustic-to-language embedding translation, according to an example embodiment.

FIG. 9 is a diagram illustrating an example of audio packet blocks configured facilitate resiliency to packet loss, according to an example embodiment.

FIG. 10 is a diagram depicting operations of an algorithm that may be used to select an encoding function of a plurality of encoding functions to achieve resiliency to packet loss, according to an example embodiment.

FIG. 11 illustrates plots comparing different ways of using a reduced number of encoding functions, according to an example embodiment.

FIG. 12 is a flow chart depicting a method to encode audio using a neural network audio codec system, according to an example embodiment.

FIG. 13 is a hardware block diagram of a device that may be configured to perform the techniques presented herein, according to an example embodiment.

### DESCRIPTION OF EXAMPLE EMBODIMENTS

### Overview

Presented herein are a neural network audio codec system and related methods. In one example, a method is provided comprising: obtaining speech audio to be encoded; applying the speech audio to an audio encoder that is part of a neural network audio codec system that includes the audio encoder and an audio decoder, wherein the audio encoder and the audio decoder have been trained with generative and adversarial loss functions of one or more deep neural network models, in an end-to-end manner using clean speech audio distorted by artifacts and impairments; encoding the speech audio with the audio encoder to generate embedding vectors that represent a snapshot of speech audio attributes over successive timeframes of the raw speech audio; and generating from the embedding vectors, codeword indices to entries in a codebook.

### Example Embodiments

### Neural Network Audio Codec System

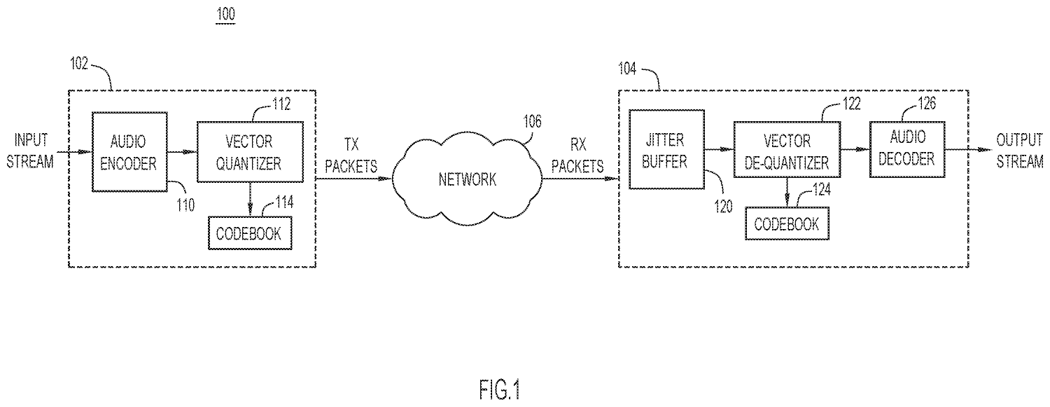

Reference is first made to FIG. 1. FIG. 1 shows a block diagram of a neural network audio encoder/decoder (codec) system 100. The neural network audio codec system 100 includes a transmit side 102 and a receive side 104, which may be separate at devices that are in communication with each other via network 106. The network 106 may be a combination of (wired or wireless) local area networks, (wired or wireless) wide area networks, public switched telephone network (PSTN), etc.

At the transmit side 102, there is an audio encoder 110 and a vector quantizer 112. The vector quantizer uses a codebook 114. The audio encoder 110 receives an input audio stream (that includes speech as well as artifacts and impairments). The audio encoder 110 may use a deep neural network that takes the input audio stream and transforms it frame-by-frame into high-dimensional embedding vectors that keep all the important information in the frame and optionally removes unwanted information such as the artifacts and impairments. The duration of the frames may be 10-20 millisecond (ms), for example. The audio encoder 110 may be composed of convolutional, recurrent, attentional, pooling, or fully connected neural layers as well as any suitable nonlinearities and normalizations. In one example, the audio encoder 110 uses a causal convolutional network with zero algorithm latency. The convolutional network may consist of convolutional blocks, and each convolutional block may be a stack of multiple residual units (1-dimensional (1-D) convolutional layer with residual connection) and finishes with a 1-D convolutional layer with stride for down-sampling. The vector quantizer 112 quantizes the high-dimensional embedding vectors at the output of the audio encoder 110. For example, the vector quantizer 112 may use techniques such as Residual Vector Quantization by selecting a set of codewords (from the codebook 114) from each layer to optimize a criterion reducing quantization error at the output stream on receive side. Thus, vector quantization is further compressing the embedding vectors into codewords, using a residual vector quantization model. The output of the vector quantization operation may also be referred to as compact or compressed speech vectors or compact speech tokens. The indices of the selected codewords for each frame are put into transmit (TX) packets and sent to the receive side 104, or they may be stored for later retrieval and use. In some implementations, the audio encoder 110 may generate the quantized vectors (indices) directly without the need for a separate vector quantizer 112.

The receive side 104 obtains receive (RX) packets from the network 106. At the receive side 104, there are a jitter buffer 120, vector de-quantizer 122, codebook 124 and an audio decoder 126. The jitter buffer 120 keeps track of the incoming packets, putting them in order and deciding when to process and play a packet. The vector de-quantizer 122 de-quantizes received codeword indices and using the codebook 124, outputs recovered embedding vectors. The audio decoder 126 decodes the embedding vectors to produce an output audio stream. Again, in some implementations, the audio decoder 126 may generate the directly perform vector de-quantization without the need for a separate vector de-quantizer 122.

Though not specifically shown in FIG. 1 there may be an encoder, vector quantizer, vector de-quantizer and decoder at each device to enable two-way communications.

Techniques are provided for a generative artificial intelligence (AI) architecture built on the neural network audio codec system 100 shown in FIG. 1. At the core of this architecture is a compact speech vector that has great potential for a wide range of speech AI and other applications. The unified architecture offers a versatile solution applicable to various content, including but not limited to: speech enhancement (such as background noise removal, de-reverberation, speech super-resolution. bandwidth extension, gain control, and beamforming), packet loss concealment (with or without forward error correction (FEC)), acoustic speech recognition (ASR), speech synthesis, also referred to as text-to-speech (TTS), voice cloning and morphing, speech-to-speech translation (S2ST), and audio-driven large language model (AdLLM).

### Training the Neural Network Audio Codec System

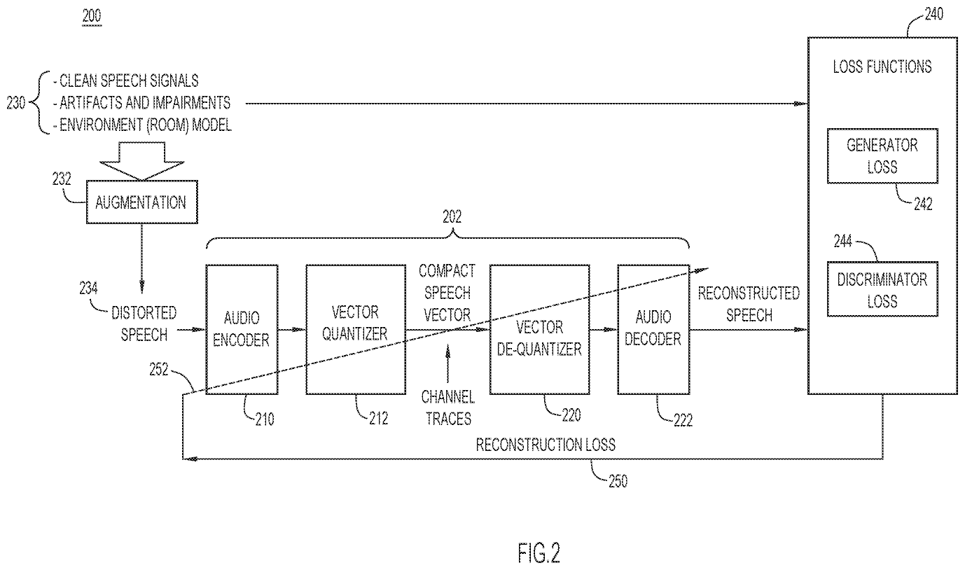

Reference is now made to FIG. 2. FIG. 2 shows an arrangement 200 by which components of a neural network audio codec system 202 are trained end-to-end using thousands of hours of speech and artifacts and impairments. Similar to FIG. 1, the neural network audio codec system 202 includes an audio encoder 210, vector quantizer 212, vector de-quantizer 220 and audio decoder 222, and each of these components may use a neural network model (or more generally machine learning-based model) for their operations.

To train the neural network audio codec system 202, as shown at reference numeral 230 various artifacts and impairments are applied to the clean speech signals through an augmentation operation 232 to produce distorted speech 234. The artifacts and impairments may include background noise, reverberation, band limitation, packet loss, etc. In addition, an environment model, such as a room model, may be used to impact the clean speech signals. The distorted speech 234 is then input into the codec system 202.

The training process involves applying loss functions 240 to the reconstructed speech that is output by the audio decoder 222. The loss functions 240 may include a generative loss function 242 and an adversarial/discriminator loss function 244. The loss functions 250 output a reconstruction loss that, as shown at 250, is used to adjust parameters of the neural network models used by the audio encoder 210, vector quantizer 212, vector de-quantizer 220 and audio decoder 222, as shown at 252. Thus, the neural network models used by the audio encoder 210, vector quantizer 212, vector de-quantizer 220 and audio decoder 222 may be trained in an end-to-end hybrid manner using a mix of reconstruction and adversarial losses.

As a result of this training, the audio encoder 210 takes raw audio input and leverages a deep neural network to extract a comprehensive set of features that encapsulate intricate speech and background noise characteristics jointly or separately. The extracted speech features represent both the speech semantic as well as speech stationary attributes such as volume, pitch modulation, accent nuances, and more. This represents a departure from conventional audio codecs that rely on manually designed features. In the embodiments presented herein, the neural network audio codec systems learns and refines its feature extraction process from extensive and diverse datasets, resulting in a more versatile and generalized representation.

The output of the audio encoder 210 materializes as an embedding vector, with each vector encapsulating a snapshot of audio attributes over a timeframe. The vector quantizer 212 further compresses the embedding vector into a compact speech vector, i.e., codewords, using a residual vector quantization model. The codeword indices streams are ready for transmission or storage. At the receiving end, the audio decoder takes the compressed bitstream as input, reverses the quantization process, reconstructs the speech into time-domain waveforms.

The end-to-end training may result in a comprehensive and compact representation of clean speech. This is a data-driven compressed representation of speech, where the representation has a lower dimensionality that makes it easier to manipulate and utilize than if the speech were in its native domain. By “data-driven” it is meant that the representation of speech is developed or derived through ML-based training using real speech data, rather than a human conjuring the attributes for the representation. The data used to train the models may include a wide variety of samples of speech, languages, accents, different speakers, etc.

In the use case of speech enhancement, the compact speech vector represents “everything” needed to recover speech but discarding anything else related to artifacts or impairments. Thus, for speech enhancement applications, the neural network audio codec system does not encode audio, but rather, encodes only speech, discarding the non-speech elements. In so doing, the neural network audio codec system can achieve a more uniquely speech-related encoding, and that encoding is more compact because it does not express the other aspects that are included in the input audio. Training to encode speech is effectively training to reject everything else, and this can result in a stronger speech encoded foundation for any other transformation to or from speech.

### Loss Functions Useful During Training

Reconstruction losses may be used to minimize the error between the clean signal, known as a target signal, x and an enhanced signal generated by the neural network audio codec, denoted \hat{x}, which is denoised and de-reverberated and/or with concealed packet/frame loss of its input signal y, noisy, reverberated audio signal and/or with lost packets/frames. One or more reconstruction losses may be used in the time domain or time-frequency domain.

A loss in the time domain may involve minimizing a distance between estimated clean \hat{x} and the target signal x in the time domain:

$${ℒ}_{𝔱} = {\sum }_{n = 1}^{N} \vert x [ n ] - \hat{x} [ n ] \vert ,$$

where [symbol] ₜ is the L1 norm loss and N denotes to number of samples of \hat{x} and x in the time domain, where L1 Norm is a sum of the magnitudes of the vectors in a space and is one way to measure distance between vectors (sum of absolute difference of components of the vectors). In some implementations, the L1 norm loss and/or the L2 norm loss may be used.

A weighted signal-to-distortion radio (weighted SDR) may be used, where the input signal y is represented as x with additive noise n: y=x+n, then SDR loss is defined as:

$${ℒ}_{S D R} ( x , \hat{x} ) = - \frac{〈 x , \hat{x} 〉}{‖ x ‖ ‖ \hat{x} ‖} ,$$

where the operator [symbol] , [symbol] represents the inner product and ∥, ∥ represents Euclidean norm. This loss is phase sensitive with the range [−1,1]. For noise only samples, to be more precise, a noise prediction term is added to define the final weighted SDR loss:

$${ℒ}_{S D R} ( x , n , \hat{n} ) = {ℒ}_{S D R} ( x , \hat{x} ) + {ℒ}_{S D R} ( n , \hat{n} ) ,$$

where \hat{n}=y−\hat{x} is estimated noise.

Multi-scale Short-Time Fourier Transform (MS STFT) operates in the frequency domain using different window lengths. This approach of using various window lengths is inspired by the Heisenberg Uncertainty Principle, which shows that a larger window length gives greater frequency resolution but lower time resolution, and the opposite for a shorter window length. Therefore, the MS STFT uses a range of window lengths to capture different features of the audio waveform.

The loss is defined as:

$${ℒ}_{MSTFT} = {\sum }_{l = 1}^{L} {\sum }_{k = 1}^{K} \vert {S}^{w} [ l , k ] - {\hat{S}}^{{}_{{}_{w}}} [ l , k ] \vert + {α}_{w} {\sum }_{l = 1}^{L} {\sum }_{k = 1}^{K} \sqrt{{\vert log ( {S}^{w} [ l , k ] ) - log ( {\hat{S}}^{{}_{{}_{w}}} [ l , k ] ) \vert}^{2}} ,$$

where S^{w}[l, k] is the energy of the spectrogram at frame l and frequency bin k and characterized by a window w, K is the number of frequency bins, L is the number of frames and α_{w} is a parameter to balance between L1 Norm and L2 Norm part of the loss, where the L2 Norm is the square root of the sum of the entries of a vector. The second part of the loss is computed using a log operator to compress the values. Generally, most of the energy content of speech signal is concentrated below 4 kHz. Therefore, the energy magnitude in lower frequency components is significantly higher than higher frequency components, with going to log domain, the magnitude of higher frequencies and lower frequencies get closer, thus more focus on higher frequency components compared to linear scale. A high-pass filter can be designed to improve performance for high-frequency content.

A Mean Power Spectrum (MPS) loss function aims to minimize the discrepancy between the mean power spectra of enhanced and clean audio signals in the logarithmic domain using L2 Norm.

The power spectrum of the signal is computed as below:

$$P ( x ) = 1 / N {\sum }_{n = 0}^{N - 1} {\vert {X}_{n} \vert}^{2} ,$$

where P(x) is the mean power spectrum of signal x, X is FFT/STFT of signal x.

A logarithm may be applied to the mean power spectrum, such that the logarithmic power spectrum of a signal x is:

$$L ( x ) = 10 {log}_{10} ( P ( x ) + ϵ ) ,$$

where ∈ is a small constant to prevent the logarithm of zero.

The MPS loss between the enhanced and clean signals can then be defined as the L2 Norm of the difference between their logarithmic power spectra:

$$ℒ os s ( \hat{x} , x ) = \sqrt{\sum {( L ( \hat{x} ) - L ( x ) )}^{2}} .$$

Generative Adversarial Networks (GANs) comprise two main models: generator and discriminator. In the neural network codec system, the audio encoder, vector quantizer and audio decoder may employ GAN generator and discriminator models. As an example, two adversarial loss functions could be used in the neural network audio codec system: Lease-squared adversarial loss functions and hinge loss functions.

Least square (LS) loss functions for discriminator and generator may be respectively defined as:

$${ℒ}_{A D V} ( D ; G ) = {E}_{( x , s )} [ {( D ( x ) - 1 )}^{2} + {D ( G ( y ) )}^{2} ] , {ℒ}_{A D V} ( G ; D ) = {E}_{d} [ D {( G ( y ) - 1 )}^{2} ] ,$$

For discriminator loss, [symbol] _{ADV} (D;G), E_{(,)} is the expectation operator, D(x), is the output of the discriminator for a real signal x, D(G(y)) is the discriminator output of enhanced (fake) signal and [symbol] _{ADV} (G;D) is the generator loss.

Hinge loss for the discriminator and generator may be defined as:

$${ℒ}_{A D V} ( D ; G ) = {E}_{( x , y )} [ max ( 1 - D ( x ) , 0 ) + max ( 0 , 1 + D ( G ( y ) ) ) ] , {L}_{A D V} ( G ; D ) = {E}_{y} [ max ( 1 - D ( G ( y ) ) , 0 ) ] ,$$

Hinge loss may be preferred over least square loss because in the case of discriminator loss, hinge loss tries to maximize the distance between the real signal and fake signal while LS loss tries to score 1 when the input is a “real signal” and 0 when the input is “fake signal”.

In addition to above-mentioned losses, feature matching may be used to minimize the difference between the intermediate features of each layer of real and generated signals when passed through the discriminator. Instead of solely relying on the final output of the discriminator, feature matching ensures that the generated samples have similar feature statistics to real samples at various levels of abstraction. This helps in stabilizing the training process of adversarial networks by providing smoother gradients. Feature matching loss may be defined as:

$${ℒ}_{F M} ( G ; D ) = {E}_{( x , y )} [ {\sum }_{i = 1}^{T} \frac{1}{{N}_{i}} {‖ {D}^{i} ( x ) - {D}^{i} ( G ( y ) ) ‖}_{1} ] ,$$

where Nᵢ is the number of layers in the discriminator D, and superscript i is used to design the layer number. Note that feature matching loss updates only generator parameters.

Several different discriminator models may be suitable for use in the training arrangement of FIG. 2, including: Multi-Scale Discriminator (MSD), Multi-Period Discriminator (MPD) and Multi-Scale Short-Time Fourier Transform (MS-STFT).

For a MSD, the discriminator is looking at the waveform at the different sampling rates. The waveform discriminators have the same network architecture but use different weights. Each network is composed of n number of strided 1-dimensional (1D) convolution blocks, an additional 1D convolution, and global average pooling to output a real-value score. A “leaky” rectifier linear unit (Leaky ReLu) may be used between the layers for the purpose of non-linearity of the network.

A MPD operates on the time-domain waveform and tries to capture implicit periodicity structure of the waveform. In an MPD discriminator, different periods of the waveform are considered. For each period, the same network architecture, with different weights, are used. The network consists of n strided two-dimensional (2D) convolution blocks, an additional convolution, and a global average pooling for outputting a scalar score. In the convolution block weight normalization may be used along with a Leaky ReLu as an activation function.

An MS-STFT discriminator, unlike the MSD and MPD, operates in the frequency domain using a Short-Time Fourier Transform (STFT). This discriminator enables the model to analyse the spectral content of the signal. The MS-STFT discriminator analyzes the “realness” of the signal at multiple time-frequency scales or resolutions. Having spectral content of the waveform in various resolutions, the model is able to analyze the “realness” of the waveform more profoundly. The MS-STFT discriminator may be composed of t equivalent networks that handle multi-scaled complex-valued STFTs with incremental window lengths and corresponding hop sizes. Each of these networks contains a 2D convolutional layer, with weight normalization applied, featuring a n×m kernel size and c number of channels, followed by a Leaky ReLu non-linear activation function. Subsequent 2D convolution layers have dilation rates in the temporal dimension and an output stride of j across the frequency axis. At the end we have d×d convolution with stride 1 followed by flatten layer to get the output scores.

Finally, the total loss of adversarial training may be defined as:

$$ℒ = {λ}_{F M} {ℒ}_{F M} + {λ}_{MSTFT} {L}_{MSTFT} + {λ}_{G} {L}_{A D V} ( G ; D ) + {λ}_{D} {L}_{A D V} ( D ; G ) + {λ}_{𝔱} {L}_{𝔱} + {λ}_{S D R} {ℒ}_{S D R} ,$$

where λ coefficients are used to give more weights to some losses compared to the other losses, [symbol] _{FM} is the feature matching loss. [symbol] _{MSTFT} is MS-STFT loss that can be replaced by [symbol] _{MSD} for MSD discriminator or [symbol] _{MPD} for MPD discriminator.

Any one or more of the loss functions referred to above, or other loss functions now known or hereinafter developed, may be used in the training process depicted in FIG. 2. The architecture of the end-to-end training, from the encoder side to the decoder side, produces the embedding vectors that can be exploited for a variety of applications as described below. The training results in an embedding vector representation that lends itself to convergence, accuracy, etc. Again, this is a result of the characteristics that are trained for, selection of loss functions, training content, selection criteria for epics, etc., to arrive at the embedding vectors that have desirable characteristics of: rejecting non-speech (for speech enhancement applications), easy to encode speech, and durability across speech applications.

As explained above, the neural network audio codec system presented herein has a variety of applications, including but not limited to: speech enhancement (such as background noise removal, de-reverberation, speech super-resolution. bandwidth extension, gain control, and beamforming), packet loss concealment (with or without forward error correction (FEC)), acoustic speech recognition, speech synthesis, also referred to as text-to-speech, voice cloning and morphing, speech-to-speech translation, and audio-driven large language model.

### Speech Enhancement

The neural network audio codec system architecture presented herein can be used for speech enhancement by which speech components are separated out from other sound events (e.g., the aforementioned artifacts and impairments, such as background noise). Thus, the neural network audio codec system projects the input speech to artifact-free speech features. This results in removal or suppression of the artifacts or impairments often experienced in audio communication, such as reverberation, saturation, and acoustic/electronic system shaping and bandwidth limitations. This is achieved by training the audio encoder (along with vector quantization) to encode degraded speech content into high-quality speech vectors by ignoring artifacts and impairments. By doing so, the derived speech vectors are more condensed compared to vectors encompassing both pristine speech and the complete array of impairments.

### Noise Robust Automatic Speech Recognition (ASR)

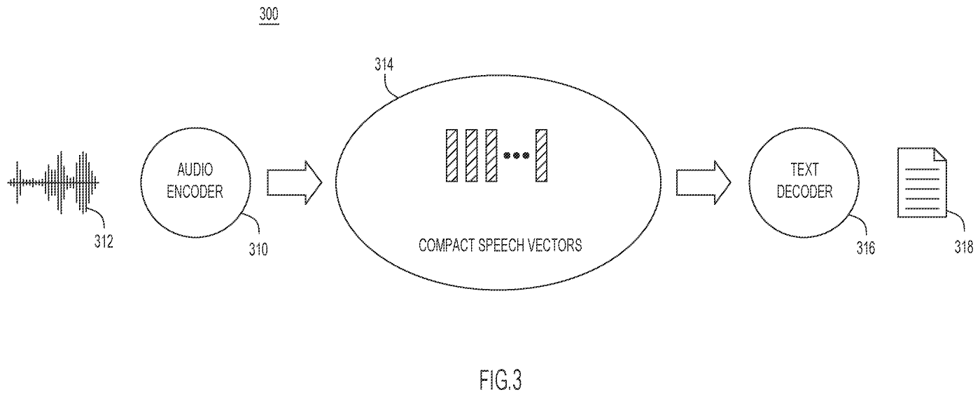

FIG. 3 shows a block diagram of a system 300 having an audio encoder 310 that has been trained according to the techniques described above in connection with FIG. 2, and encodes real/raw audio 312 to produce compact speech vectors 314 (after vector quantization) that are then supplied to a text decoder 316 to produce text 318. As explained above, the compact speech vectors 314 retain essential information about the spoken content, such as phonetic content and prosody. As a result, the text decoder 316 can associate speech features, represented by the speech vector, with the corresponding textual content in the output text 318. The text decoder 316 may be based on a neural network sequence-to-sequence translator model that is trained to translate compact speech vectors (codeword indices) to words, e.g., a sequence of words, of a given language. The text decoder 316 then outputs text representing the sequence of words. Again, the compact speech vectors 314 maintain the integrity of the speech even in the presence of noise and reverberation, which are well-documented sources of performance degradation in most automatic speech recognition systems. The text decoder 316 thus operates as a language model to aid the mapping of a series of speech sounds (as represented, for example, by compact speech vectors for each 10 ms or 20 ms frame) to the most likely sequence of text words in a given language. The representation of speech as a vector sequence enables a higher quality and/or more computationally efficient sequence-to-sequence mapping through a language model, compared to previous methods that use phonemes or ad hoc representations of speech sounds.

### Speech-to-Speech Translation

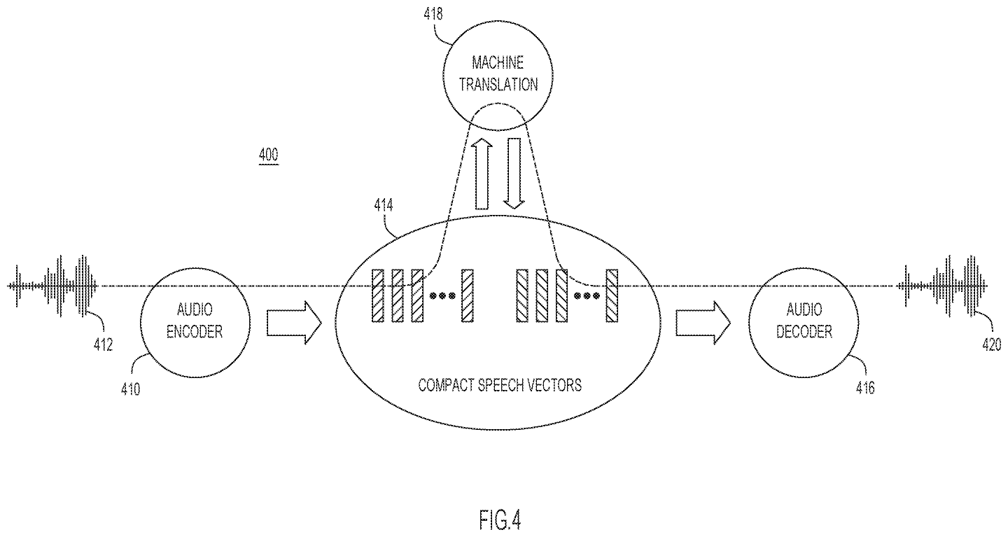

FIG. 4 shows a block diagram of a system 400 that leverages the compact speech vector capabilities presented herein for speech-to-speech translation. Speech-to-speech translation (S2ST) aims to convert speech from one spoken language to another language, providing real-time translation of conversations. The system 400 uses an audio encoder 410 that has been trained according to the techniques described above in connection with FIG. 2, to encode real/raw audio 412 to produce compact speech vectors 414 (after vector quantization). The system 400 further includes an audio decoder 416 (which may also have been trained as explained above) and a machine translation process 418. relying on a proposed innovation—the representation of the sequence-to-sequence language mapping as a mapping between compact vectors as input and output.

The machine translation process 418 operates on the compact speech vectors 414 to translate/map them from a source language (of the real/raw audio 412) to a target language, without converting speech vector to text, performing text translation, and text-to-speech conversion back to audio. The machine translation process 418 outputs translated compact speech vectors that are then provided to the audio decoder 416 that converts the translated compact speech vectors to speech audio 420 in the target language. The machine translation process 418 may perform this translation by taking a sequence of indices (to codewords in a codebook) representing the speech audio in a source language to another sequence of indices (to codewords in a codebook) representing that same speech audio (those same words) in a target language. Thus, the machine translation process 418 has a priori been trained to map codewords in the source language to codewords in the target language using known language translation techniques, but applied to codebook indices. With less processing in the processing pipeline, information loss and error propagation may be avoided, save processing time, and reduce computing cost.

### Voice Cloning and Morphing

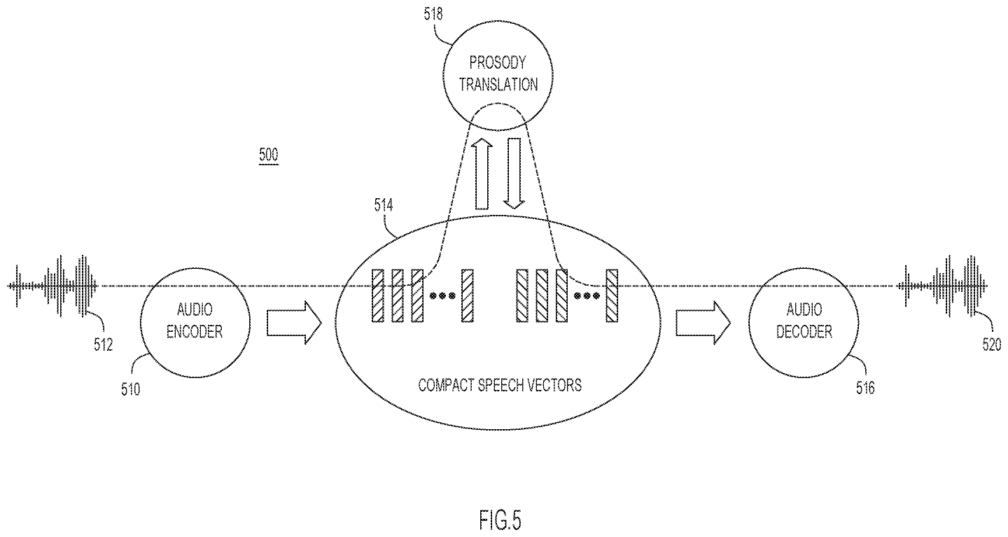

Reference is now made to FIG. 5, which illustrates a system 500 that is similar to that of FIG. 4, with the exception of the translation process used. FIG. 5 shows an audio encoder 510 that receives input raw/real audio 512 and produces compact speech vectors 514 (after vector quantization). In other words, the prosody translation process 518 maps the rhythm, stress and intonation of speech of a first type to the rhythm, stress and intonation of that of a second type. A prosody translation process 518 is provided that maps the speech vectors from a source prosody of one speaker to a target prosody of another speaker. The audio encoder 516 decodes the speech vectors in the target prosody to audio 520 in the target prosody.

As an example, the compact speech vectors 514 output by the encoder 510 are converted to indices to represent audio from speaker A (with a source prosody). The prosody translation process 518 performs a mapping of the indices for speaker A to indices for a codebook of speaker B. This is analogous to projecting, in the compressed speech representation domain, the indices for speaker A onto indices for speaker B.

Text-to-Speech (TTS) with Custom Voice

Typical text-to-speech systems include several components, including text tokenization, phonemes or linguistic feature extraction, acoustic modeling, waveform generation, and prosody and intonation incorporation. The speech vectors that the neural network audio codec system described herein generates represent phonetic, lexical, and semantic information, as well as characteristics like intonation, prosody, accent, and sentiment. Thus, these speech vectors can be exploited in a unique way in a text-to-speech system.

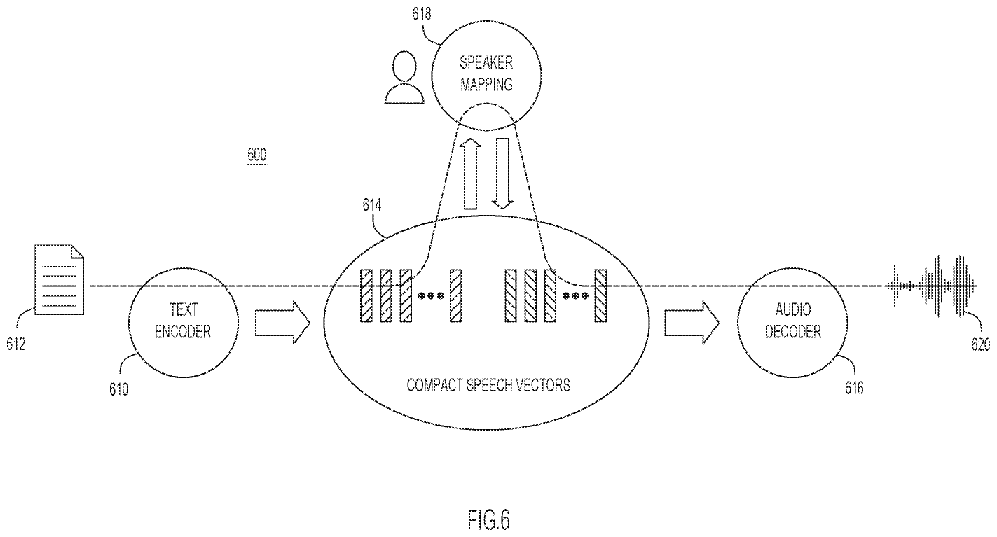

FIG. 6 shows a block diagram of a system 600 that includes a text encoder 610 that encodes input text 612 and converts it to compact speech vectors 614. An audio decoder 616 is provided to reconstruct audio waveform from the compact speech vectors. The text encoder 610 is trained to convert text to compact speech vectors by first training a model to convert a sequence of text, e.g., a sentence, to a sequence of distinct units of speech perceived by human or machine. Then, a sequence-to-sequence translator is trained to convert the sequence of distinct units of speech to compact speech vectors.

The compact speech vectors 614 generated by the text encoder 610 are provided to a speaker mapping process 618. The speaker mapping process 618 maps the speech vector for a common or default voice prosody to custom speech vectors associated with a desired real speaker (voice prosody) or a custom artificially created speaker's voice prosody. This is similar to the voice morphing or cloning process depicting in FIG. 5, but where the starting point is text rather than speech audio. The mapped compact speech vectors output by the speaker mapping process 618 are then provided to the audio decoder 616 which derives the output audio 620 in a prosody of a desired real speaker or custom artificially created speaker. Thus, the system 600 converts text to a generic speaker voice and then morphs it into another speaker's voice (prosody).

### Direct Speech Query to Large Language Model Embeddings

Large Language Models (LLMs) are a revolutionary breakthrough in the realm of artificial intelligence. These models are typically trained on vast amounts of text data, enabling them to perform a wide range of natural language processing tasks. Recently, there has been a burgeoning interest in leveraging audio as an input modality for LLMs. Using ASR, audio content is converted into text, allowing LLMs to subsequently process and interpret the converted text. However, integrating ASR processing into LLMs may present challenges, such as the risk of error propagation, diminished semantic richness, heightened latency, and other associated concerns. To address these challenges, we propose the utilization of compact speech vectors to bridge the gap between audio input and LLMs. The LLM contains two parts: (i) embedding encoding, and (ii) text generator, which takes the embeddings as input. Techniques are presented in which the audio embeddings are taken and translated into LLM embeddings.

It is also possible that the LLM may be directly adapted to receive as input compact vectors encapsulating speech and background noise characteristics jointly or separately. It may generate a companion stream of prosody information, alongside the standard text stream. Another envisioned variant is to send the full lattice of word probabilities from ASR to the LLM. That is, information is provided to the LLM that captures the inherent ambiguity of mapping from speech to text, so that the LLM can make decisions about speech intent in the much larger context of its language model and the current query.

As explained above, current speech-based LLM systems predominantly rely on an ASR-based approach, where raw acoustic signals are first transcribed into textual form and are then processed further for understanding and generating responses. This two-stage process has inherent inefficiencies for several reasons.

Error Propagation: Any inaccuracies in the ASR phase are propagated and often exacerbated in subsequent natural language processing tasks. For instance, mis-recognizing a spoken word can alter the entire semantic meaning of a sentence.

Latency Issues: Real-time applications demand swift processing. The two-stage process of first converting speech to text and then processing this text introduces unnecessary latencies.

Loss of Semantic Richness: The intermediate textual representation might not capture all the nuances and intricacies of the original spoken content, leading to a potential loss in semantic richness.

Security Concern: The intermediate textual information produced by ASR is human-readable, making it susceptible to unauthorized access and potential breaches of privacy. Acoustic embeddings (compact speech vectors and then the codebook indices that are generated from the vectors), on the other hand, are non-human-readable representations, offering an added layer of security by obscuring the content from immediate comprehension by potential malicious actors.

The challenge lies in developing a system that can efficiently bridge the gap between acoustic signals and their corresponding semantic meanings without the need for an intermediate textual representation. Such a system would streamline the process, potentially reduce errors, and cater more effectively to real-time applications, as well as offering a heightened level of security by mitigating the risks associated with human-readable text data.

Embeddings in LLMs are high-dimensional vectors generated in hidden layers that encapsulate semantic, syntactic, and contextual information about the tokens they represent. The process of generating embeddings for LLMs may involve several steps.

Tokenization: The text of an input sentence is tokenized into individual tokens. Tokens can be words, sub-words, characters, or even byte pairs, depending on the tokenization strategy used.

Token Embeddings: Each of these tokens is then mapped to a token embedding.

Positional Embeddings: Positional embeddings are added to give the model information about the position of a token in a sequence.

Summation: The token and positional embeddings for each token are summed to produce a combined embedding for each token.

Transformer Layers: The embeddings then pass through transformer layers, where they are processed and transformed. After passing through all the transformer blocks, one embedding is produced for each token, but the tokens have been updated based on the context of the entire input sequence.

These language embeddings can be fine-tuned or used directly for both text generation tasks (e.g., question answering, summarization, story writing etc.) and discriminative tasks (semantic search, classification, etc.).

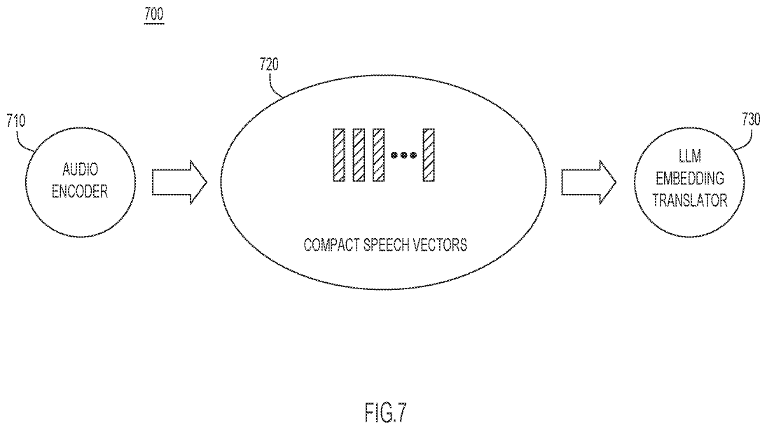

FIG. 7 illustrates a system 700 that includes an audio encoder 710 that outputs compact speech vectors 720 that are provided to an LLM embedding translator process 730. The LLM embedding translator process 730 converts or translates the acoustic embeddings (a sequence of compact speech vectors 720 and the codebook indices that are derived from the speech vectors) to LLM embeddings. The extracted speech representations preserve rich speech semantics and are separated from background noise. These acoustic embeddings are generated during a fixed temporal window (e.g., every 10 ms).

The LLM embedding translator process 730, also called herein a “translator”, is trained to perform this conversion or translation from acoustic embeddings derived from the compact speech vectors into language embeddings used by LLMs. The system 700 leverages deep learning techniques to understand and generate textual content based on acoustic inputs, thus bridging the gap between speech understanding and natural language processing tasks.

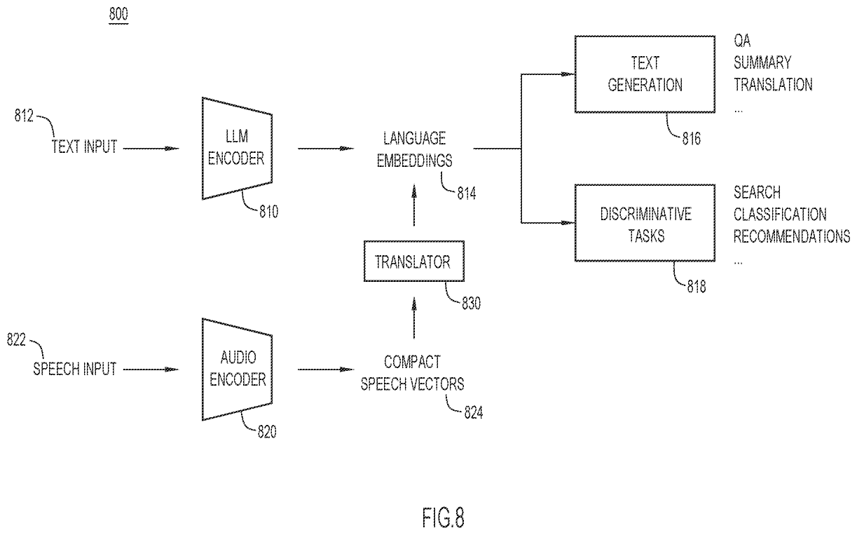

FIG. 8 illustrates a diagram of a speech-based LLM using acoustic-to-language embedding translation system 800. In this figure, there is a pretrained LLM encoder 810 that is configured to encode text input 812 and produce language embeddings 814. The language embeddings may then be used for text generation 816 (e.g., for question-answer, summary, translation, etc.) and/or for performing discriminative tasks 818 (e.g., searching, classification, recommendations, etc.)

At the bottom of FIG. 8 is a pre-trained audio encoder 820. The audio encoder 820 has already been trained using the techniques described above in connection with FIGS. 1 and 2. The audio encoder 820 receives speech audio input 822 and generates compact speech vectors (codeword indices) 824. The translator 830 (which is the same as the LLM tokenizer process 730 shown in FIG. 7) maps codeword indices 824 to language embeddings also known as LLM embeddings. The translator 830 is trained to perform this mapping.

Constructing a translator from acoustic embeddings to LLM embeddings presents certain challenges:

Temporal Dynamics: the speech signals, when directed towards a single LLM embedding, might show significant variation in their length. Hence, the conversion needs to manage acoustic embeddings that come in diverse sizes.

Information Distillation: the information in acoustic embeddings is not limited to just linguistic content; it often carries details about the speaker, such as their gender, age, regional accent, emotional state, physical attributes, and pace of speech. The translator may remain invariant to these speaker-specific variations in the acoustic embeddings. In one example, the translator may be configured to extract prosody information in addition to linguistic content in standard text.

To address these challenges, the following is provided for in the translator 830.

Transformer: Self-attention and cross-attention mechanisms in the transformer model are used in the translator 830 that allow each embedding in the output sequence to attend to all embeddings in the input sequence. This provides flexibility in mapping different-length sequences on the input.

End-of-sequence token: The translator 830 is trained to produce an end-of-sequence token. When the translator 830 generates this token, this indicates that the translation is complete. This allows for variable output sequence lengths, as the translator 830 decides when a translation is semantically complete.

Training Data: The training dataset used for training the translator 830 encompasses a broad spectrum of speaker profiles and content diversity. The audio encoder 820 might yield subtle variations in coding for identical speech segments influenced by factors like pace, temporal shifts, and speaker accents. To ensure robustness, the consistency of the language embeddings output by the translator 830 across these code variations is assessed, striving for uniform LLM responses.

### Packet Loss Resiliency

In the realm of audio and video communication, packet loss refers to the phenomenon where data packets that carry audio or video information are not successfully received at their intended destination. These packets can be lost due to various factors such as network congestion, errors, or limitations in the communication infrastructure. One method is to use predictions of the likelihood of speakers interrupting the incoming speech and predictions of packet loss to guide target latency at the receiving end. When packet loss probability is low or probability of speakers trying to break into the incoming speech is high, the target latency at the receiving end is low to improve interactivity but with only shallow buffering to hide lost/delayed incoming speech packets. When predictions of speech probability are low, or predictions of packet loss are high, then the system increases the target latency at the receiving end to allow deeper buffering of speech at the receiver. Transitions between low latency and high latency domains are made gradually, with speech playback either sped up or slowed down to cover the change in latency as seamlessly as possible. With good prediction, the system appears to behave as if it has low latency for easy speaker break-in and deep buffering to hide inconsistent packet arrival.

The neural network audio encoder presented above can overcome the limitations of conventional methods by enabling the encoding of significantly larger audio content within each frame. When paired with a jointly trained decoder, content from the currently received frame can be retrieved alongside one or more preceding frames. This enables an implicit concealment capability within the neural network audio codec system.

For purposes of this description related to packet loss resiliency, reference is made back to FIG. 1. The audio encoder receives one audio frame at a time and outputs an embedding vector with 320 components, for example. In one example, the length of one audio frame is 10 ms. The embedding vector goes through several stages (e.g., six stages) of residual vector quantization; each of the stages gives a 10-bit index, for example, totaling to 60 bits per audio packet and an encoding bitrate of 6 kbps, as an example. This encoding scheme allows for any rate from 1 kbps to 6 kbps in increments of 1 kbps, and this is done by keeping the corresponding number of quantization indices in the audio packet. In other words, the scheme is scalable by design.

Voice over IP (VOIP) communication is considered here as an example, where audio packets are sent as payloads of network packets (usually Real-time Transport Protocol (RTP) packets). Normally, one audio packet is sent per network packet. However, to reduce the network packetization overhead, the techniques presented herein involve stacking (combining) several audio packets in a network packet and effectively increasing the size of the encoded audio frame. For example, two audio packets are sent per network packet as the main payload making the effective length of audio frames 20 ms, but that number of audio packets can be larger.

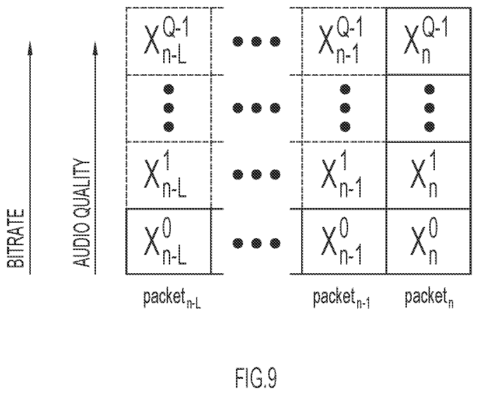

A redundant packetization scheme may be used. Packets sent over the network contain the most recent audio packet Xₙ encoded at rate R₀ and L previous audio packets Xₙ₋₁, . . . , X_{n-L} (the so-called redundant audio packets) at rates R₁, . . . , R_{L}, respectively. A simple, yet practical, case is described where R₀=6 kbps and R₁, . . . , R_{L}=Rᵣ=1 kbps. A goal is to efficiently encode the quantized codeword indices, with a particular focus on the low-bitrate redundant audio packets. The network packet payload that consists of the main and redundant audio packets is referred to as the audio packet block and it is illustrated in FIG. 9. The superscript is omitted since redundant packets contain only the output of the first vector quantization layer.

Since network packets can be lost, audio packet blocks should be independently decodable, meaning that the decoder does not need to maintain a state, and audio blocks are encoded and decoded independently of one another.

A method is now described that can reduce the bitrate of the redundant audio packets. Without entropy coding, those are represented by 10-bit symbols (quantization indices) at an effective rate of 1 kpbs, as was previously mentioned. The redundant part of an audio packet block with time index n is a vector of symbols:

$${b}_{r} = {[ {X}_{n - 1} … {X}_{n - L} ]}^{⊤} .$$

The encoding of symbols Xₙ₋₁, . . . , X_{n-L} can be done independently, one symbol at a time. The corresponding encoding rate is lower bounded by the symbol entropy H(Xₙ). However, one expects consecutive symbols to be correlated and allow for a more efficient encoding. Due to time and memory complexity, inter-symbol correlation can be exploited by modeling a sequence of symbols Xₙ with a first-order Markov model, i.e., P (Xₙ₋ᵢ|Xₙ₋ᵢ₊₁, . . . , Xₙ)=P(Xₙ₋ᵢ|Xₙ₋ᵢ₊₁). However, this can be generalized to Markov models of higher orders.

For the first-order Markov, symbol probabilities and conditional probabilities are used. The former can be represented by a vector p=[p₀ . . . p_{N-1}]^{T}, where pᵢ=P (Xₙ=i). Similarly, symbol conditional probabilities can be represented with N vectors p₀, . . . , p_{N-1}, each of length N, where p_{i,j}=P (Xₙ₋₁=j|Xₙ=i).

Symbol probabilities and conditional probabilities can be estimated from encodings of a large and diverse audio dataset. Analysis on a Librispeech dataset (corpus of approximately 1000 hours of 16 kHz read English speech) has shown that H(Xₙ)≈9.6 bits, while H(Xₙ₋₁|Xₙ)≈7.1 bits. This clearly indicates the advantage of encoding symbols with N encoding functions or tables (e.g., Huffman tables), Cᵢ: j→c_{i,j}, j=0, . . . , N−1, each optimized for the corresponding conditional probability distribution pᵢ. This encoding scheme is referred to as conditional because the choice of the encoding function Cᵢ is conditioned by the previous symbol's value i. Cᵢ are referred to as conditional encoding functions.

The memory complexity of encoding with N conditional encoding functions is a function of N². The alternative of computing the encoding functions “on the fly” can also be computationally too expensive. One solution, described below, uses a reduced number K of encoding functions Cᵢ, i ∈ {0, . . . , K−1}, where K can be substantially smaller than N.

The alternative entropy coding methods that do not use explicit coding functions like Huffman tables, such as arithmetic and range coding, still need to maintain the symbol probability distributions (p and {pᵢ}) in memory, and therefore they have the same memory complexity. A method proposed herein can be equally applied to cluster the conditional probability distribution vectors and reduce the memory complexity, with practically the same tradeoff between memory complexity and coding efficiency.

The analysis is made simpler if an idealized view is taken of the encoding functions Cᵢ as optimal for some probability distribution qᵢ, attaining entropy H(qᵢ).

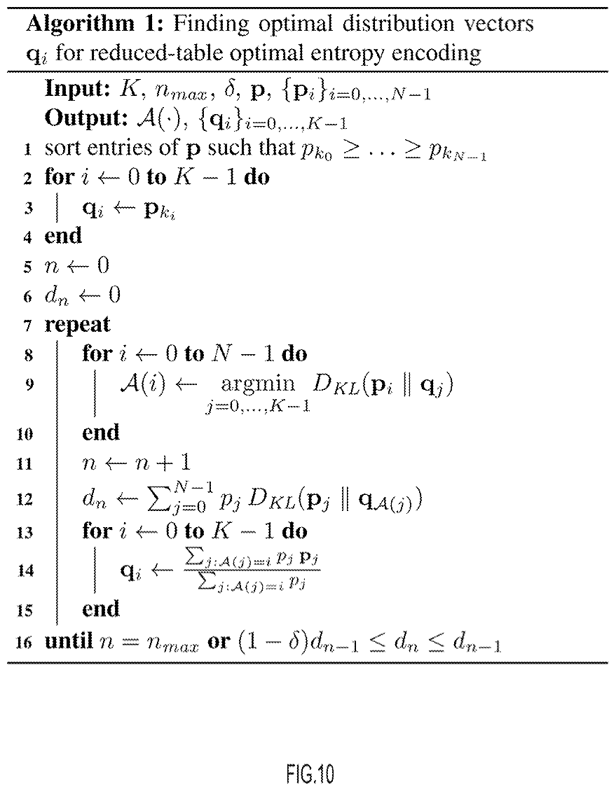

The problem of optimal encoding with K encoding functions can be expressed as finding K encoding functions Cᵢ and an assignment function A that chooses an encoding function Cᵢ based on the previous symbol value j: A(j)=i, such that symbol code length is minimized. Ultimately, the problem lends itself to optimal clustering algorithms. Algorithm 1, shown in FIG. 10, which is a variant of the K-means method, is a suitable solution.

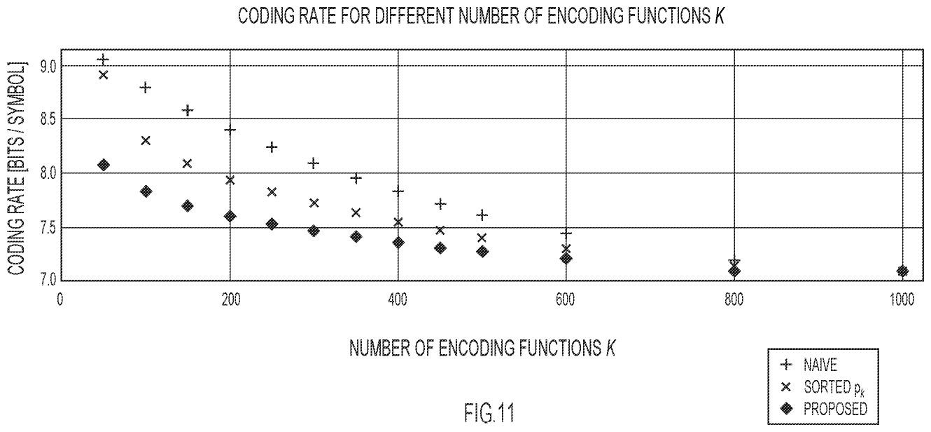

FIG. 11 compares three different ways of using a reduced number K of encoding functions. The approach called naive makes the selection of K−1 conditional encoding functions Cᵢ and encodes using one of those when the previous symbol takes on the corresponding value i; and for other previous symbol values, it uses the encoding function C optimized for single symbol encoding, i.e., using the probability distribution p. The other approach called sorted pᵢ, consists of choosing the K vectors qᵢ from the initialization step in lines 1-4 of Algorithm 1, followed by the assignment calculation, as in lines 8-10. In summary, FIG. 11 shows notable bitrate saving of the proposed method, especially for small K.

Forward Error Correction (FEC) is a known technique for packet loss. FEC operates by adding redundant information to the transmitted data packets before they are transmitted. As described above, the neural network audio codec system is capable to produce multiple bit rate streams, and a lowest bit rate is 1 kbps, for example, which is useful when FEC is used. As a result, the neural network audio codec system presented herein exhibits high resiliency to packet losses with a much lower bandwidth requirement than that of existing audio codec systems.

Forward Error Correction can take one of two forms:
1. Low-bit-rate redundancies: representations of past audio intervals are appended to the current audio description.
2. Channel protection coding: representations of current and past audio intervals are combined into special protection packets that can be used to recover lost packets at the decoder.

The extreme low bitrates described above allows for appending multiple redundancies to each packet. For example, it may be useful to append 50 payloads to potentially recover one second of lost audio (assuming one payload represents 20 ms or audio length). Such very deep redundancies involve attention to jitter buffering and time-scale modification, described below.

Relative to conventional codecs, at the system level, the recovery depth is to be determined, that is, the number of redundancies to append to each packet. For conventional codecs, packet loss statistics in the form of lost versus received packet counts are typically fed back via the Real Time Control Protocol (RTCP) but such simplistic statistics are suboptimal is this context. Ideally, the redundancies should cover exactly the loss run-lengths, as any excess is simply wasted bitrate. Therefore, an improved protocol for such a codec should represent loss run-length statistics rather than simply packet loss counts or percentages.

In an alternative embodiment, the redundancy depth is adapted/modified not by the packet loss statistics, but rather by (an estimate of) the available channel bandwidth, adding as much redundancy as can be afforded. When bandwidth is plentiful, this approach can proactively add redundancy even before any packet loss is observed and thereby better catch one-off events such as packet loss caused by network handover. Combinations of the two strategies is possible, with an example embodiment to be described below.

### End-to-End Redundancy Control

Channel protection coding is often applied hop-by-hop as a function of the packet loss observations on each hop. With conventional low-bit-rate redundancies, that can be more complicated because an intermediate hop cannot easily produce new low-bit-rate redundancies; it would have to decode the incoming stream and then re-encode to obtain the low-bandwidth redundancies. That comes at the price of increased computational cost and latency, as well as quality degradations due to transcoding. With the techniques presented herein, that problem is circumvented: any intermediate hop can easily produce low-bit-rate redundancies by stripping layers of the full 6 kbps representations at very low computational cost. These reduced bitrate representations can then be appended to subsequent packets as redundancies.

In case intermediate hops do not implement the techniques presented herein, other solutions may be performed, including:
1. The original encoder adding as much redundancy as can be afforded on its uplink.
2. These are forwarded by intermediate hops until the last hop before the receiver at which the audio will be decoded.
3. This hop can strip redundancies to save bandwidth for those receivers that do not suffer from packet loss and/or have very low available bandwidth.

Retransmission (RTX). The use of retransmission for audio can be problematic in real-time communications because it increases the end-to-end delay. In fact, the main promise of the very deep redundancies offered by low-bit-rate codecs is that it is a lower-latency alternative to retransmission. Thus, retransmission should usually not be requested when deep redundancies are in use. However, in some embodiments, the redundancy mechanism will be adaptive, and redundancies will only be transmitted when there are historic observations of packet loss; here, retransmission still has a role to play. Retransmission can be enabled but introducing a grace period before sending retransmission requests for missing frames, where the grace period depends on and growing with the redundancy depth. Thereby, deep redundancies and RTX can work gracefully in parallel.

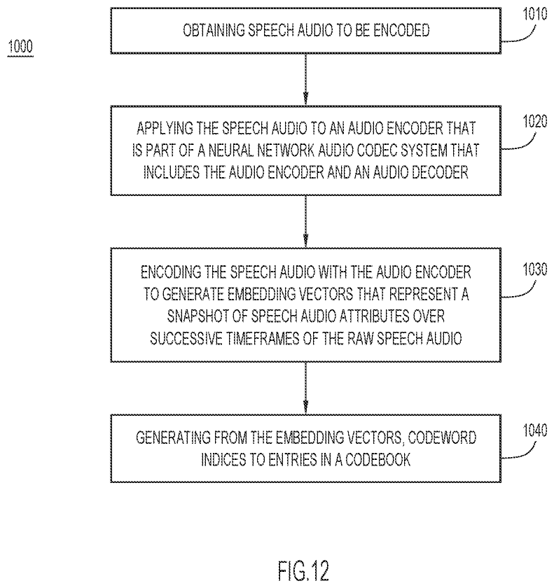

Reference is now made to FIG. 12. FIG. 12 is a flow chart that depicts a method 1000 for encoding audio using a neural network audio codec system, such as that shown in FIG. 1. At step 1010, the method 1000 involves obtaining speech audio to be encoded. The speech audio may be obtained by a microphone on a device, such as a computer microphone, video conference system microphone, microphone on a Smartphone or tablet, microphone of a desktop telephone, etc.

At step 1020, the method 1000 includes applying the speech audio to an audio encoder that is part of a neural network audio codec system that includes the audio encoder and an audio decoder. The audio encoder and the audio decoder may have been trained in an end-to-end manner. In one example, the audio encoder and audio decoder have been trained with generative and adversarial loss functions of one or more deep neural network models, in an end-to-end manner using clean speech audio distorted by artifacts and impairments.

At step 1030, the method 1000 includes encoding the speech audio with the audio encoder to generate embedding vectors that represent a snapshot of speech audio attributes over successive timeframes of the raw speech audio.

At step 1040, the method 1000 includes generating from the embedding vectors, codeword indices to entries in a codebook. The codeword indices may be stored for later retrieval and processing by the audio decoder, or may be included in a network packet that is transmitted, and ultimately decoded by the audio decoder.

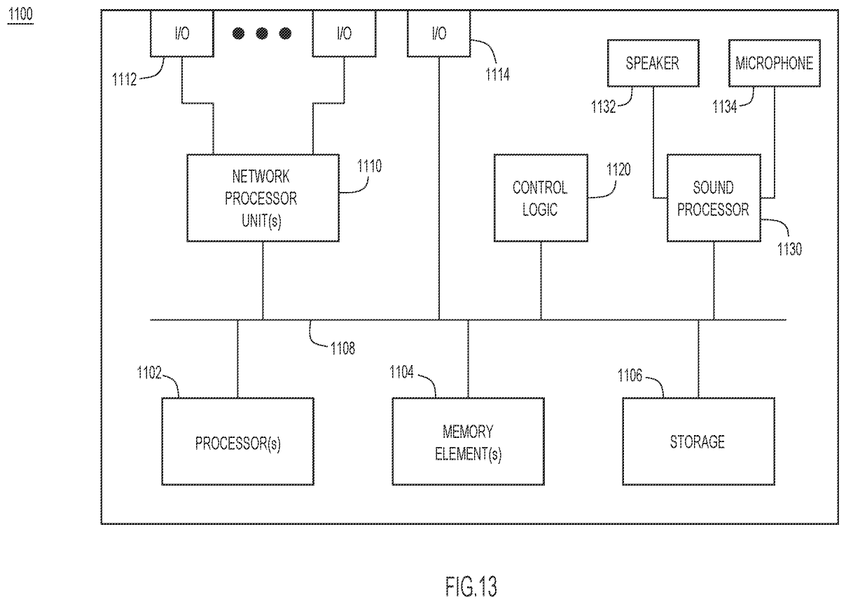

FIG. 13 is a hardware block diagram of a networking/computing device/apparatus/appliance/endpoint that may perform functions associated with any combination of operations in connection with the techniques depicted in FIGS. 1-12 described herein. It should be appreciated that FIG. 13 provides only an illustration of one example embodiment and does not imply any limitations with regard to the environments in which different example embodiments may be implemented. Many modifications to the depicted environment may be made.

In at least one embodiment, the computing device 1100 may be any apparatus that may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for computing device 1100 can overlap in any manner and are not limited to the specific allocation of instructions and/or operations described herein.

In at least one embodiment, processor(s) 1102 is/are at least one hardware processor configured to execute various tasks, operations and/or functions for device 1100 as described herein according to software and/or instructions configured for device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1104 and/or storage 1106 is/are configured to store data, information, software, and/or instructions associated with device 1100, and/or logic configured for memory element(s) 1104 and/or storage 1106. For example, any logic described herein (e.g., control logic 1120) can, in various embodiments, be stored for device 1100 using any combination of memory element(s) 1104 and/or storage 1106. Note that in some embodiments, storage 1106 can be consolidated with one or more memory elements 1104 (or vice versa), or can overlap/exist in any other suitable manner. In one or more example embodiments, process data is also stored in the one or more memory elements 1104 for later evaluation and/or process optimization.

In at least one embodiment, bus 1108 can be configured as an interface that enables one or more elements of device 1100 to communicate in order to exchange information and/or data. Bus 1108 can be implemented with any architecture designed for passing control, data and/or information between processors, memory elements/storage, peripheral devices, and/or any other hardware and/or software components that may be configured for device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to device 1100. For example, I/O interface(s) 1114 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards.

In various embodiments, control logic 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the even the device 1100 is an endpoint (such as telephone, mobile phone, desk phone, conference endpoint, etc.), then the device 1100 may further include a sound processor 1130, a speaker 1132 that plays out audio and a microphone 1134 that detects audio. The sound processor 1130 may be an sound accelerator card or other similar audio processor that may be based on one or more ASICs and associated digital-to-analog and analog-to-digital circuitry to convert signals between the analog domain and digital domain. In some forms, the sound processor 1130 may include one or more digital signal processors (DSPs) and be configured to perform some or all of the operations of the techniques presented herein.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1106 and/or memory elements(s) 1104 can store data, software, code, instructions (e.g., processor instructions), logic, parameters, combinations thereof, and/or the like used for operations described herein. This includes the storage 1106 and/or memory elements(s) 1104 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: obtaining speech audio to be encoded; applying the speech audio to an audio encoder that is part of a neural network audio codec system that includes the audio encoder and an audio decoder, wherein the audio encoder and the audio decoder have been trained in an end-to-end manner; encoding the speech audio with the audio encoder to generate embedding vectors that represent a snapshot of speech audio attributes over successive timeframes of the speech audio; and generating from the embedding vectors, codeword indices to entries in a codebook.

In some aspects, the techniques described herein relate to a method, encoding includes encapsulating speech and background noise characteristics jointly or separately.

In some aspects, the techniques described herein relate to a method, wherein the audio encoder is trained to encode degraded speech content into speech vectors by ignoring artifacts and impairments, and wherein encoding includes producing speech embedding vectors that are more condensed compared to embedding vectors encompassing speech distorted by artifacts and impairments.

In some aspects, the techniques described herein relate to a method, wherein encoding includes generating speech embedding vectors representing speech semantics and stationary attributes including volume, pitch modulation, and accents nuances.

In some aspects, the techniques described herein relate to a method, wherein the speech audio is to be converted to text, further including: decoding the codeword indices associated with the embedding vectors to produce text for the speech audio.

In some aspects, the techniques described herein relate to a method, wherein the speech audio contains speech in a first language and the codeword indices include a sequence of first codeword indices to the codebook for the first language, further including: mapping the sequence of first codeword indices to a sequence of second codeword indices to a codebook for a second language; and decoding the sequence of second codeword indices to produce an output audio stream of the speech audio in the second language.

In some aspects, the techniques described herein relate to a method, wherein the speech audio contains speech of a first prosody and the codeword indices include a sequence of first codeword indices to the codebook for the first prosody, further including: mapping the sequence of first codeword indices to a sequence of second codeword indices to a codebook for a second prosody; and decoding the sequence of second codeword indices to produce an output audio stream of the speech audio in the second prosody.

In some aspects, the techniques described herein relate to a method, further including: converting the embedding vectors to language embeddings that are suitable to be provided as input to a large language model for a text generation task or for a discriminative task.

In some aspects, the techniques described herein relate to a method, wherein converting is performed by a translator that has been trained across a broad spectrum of speaker profiles and content diversity to account for speech audio that results in embedding vectors of diverse sizes, to be invariant to speaker-specific variations, and to use one or more transformer models that account for different length sequences.

In some aspects, the techniques described herein relate to a method, wherein the converting includes providing an end-of-sequence token to indicate that conversion for a sequence of indices is complete.

In some aspects, the techniques described herein relate to a method, wherein encoding includes encoding the speech audio at any bit rate within a rate range, in increments, based on use of a corresponding number of codeword indices included in an audio packet.

In some aspects, the techniques described herein relate to a method, further including: transmitting multiple audio packets within a network packet.

In some aspects, the techniques described herein relate to a method, wherein transmitting includes transmitting network packets, each network packet including a most recent audio packet in a sequence, the most recent audio packet encoded at a first bit rate R0 and L plurality of previous audio packets in the sequence encoded at bit rates R1, . . . , RL, respectively, wherein rate R0 is greater than bit rates R1, . . . , RL.

In some aspects, the techniques described herein relate to a method, wherein bit rates R1, . . . , RL are each a second bit rate.

In some aspects, the techniques described herein relate to a method, wherein the first bit rate is 6 kbps and the second bit rate is 1 kbps.

In some aspects, the techniques described herein relate to a method, further including: decoding, with the audio decoder, the codeword indices to recover the speech audio.

In some aspects, the techniques described herein relate to a method, wherein the audio encoder and audio decoder have been trained with generative and adversarial loss functions of one or more deep neural network models in an end-to-end manner using clean speech audio distorted by artifacts and impairments.

In some aspects, the techniques described herein relate to a method including: obtaining text to be converted to speech audio; converting the text to speech vectors of a default voice prosody; mapping the speech vectors of the default voice prosody to speech vectors of a target voice prosody that is different from the default voice prosody; and decoding the speech vectors of the target voice prosody to produce output speech audio in the target voice prosody.

In some aspects, the techniques described herein relate to a method, wherein converting comprises generating first speech vectors representing speech semantics and stationary attributes including volume, pitch modulation, and accents nuances associated with the default voice prosody, and mapping comprises mapping the first speech vectors to second speech vectors for the target voice prosody.

In some aspects, the techniques described herein relate to a method, wherein decoding is performed with an audio decoder that is part of a neural network audio codec system that includes an audio encoder and the audio decoder, which has been trained end-to-end with generative and adversarial loss functions of one or more deep neural network models, using clean speech audio distorted by artifacts and impairments.

In some aspects, the techniques described herein relate to an apparatus comprising: one or more processors configured to execute instructions for an audio encoder to encode the speech audio to generate embedding vectors that represent a snapshot of speech audio attributes over successive timeframes of the speech audio, and to generate from the embedding vectors codeword indices to entries in a codebook; and a communication interface configured to transmit a bit stream that includes the codeword indices.

In some aspects, the techniques described herein relate to a method including: training with one or more loss functions of one or more deep neural network models, a neural network audio codec system that includes an audio encoder and an audio decoder, in an end-to-end manner using clean speech audio signals distorted by artifacts and impairments that, as a result of the training, produces a trained audio encoder and a trained audio decoder.

In some aspects, the techniques described herein relate to a method, further including: applying raw speech audio to the trained audio encoder to generate embedding vectors that represent a snapshot of speech audio attributes over successive timeframes of the raw speech audio.

In some aspects, the techniques described herein relate to a method, further including: generating from the embedding vectors, codeword indices to entries in a codebook.

In some aspects, the techniques described herein relate to a method, wherein training includes training the audio encoder to encapsulate speech and background noise characteristics jointly or separately.

In some aspects, the techniques described herein relate to a method, wherein training includes training the audio encoder to encode degraded speech content into speech vectors by ignoring the artifacts and impairments so as to produce speech embedding vectors that are more condensed compared to embedding vectors encompassing speech and the artifacts and impairments.

In some aspects, the techniques described herein relate to a method, wherein training includes training the audio encoder to generate speech embedding vectors representing speech semantics and stationary attributes including volume, pitch modulation, and accents nuances.

In some aspects, the techniques presented herein relate to a method comprising: obtaining text to be converted to speech audio; converting the text to speech vectors of a default voice prosody; mapping the speech vectors of the default voice prosody to speech vectors of a target voice prosody that is different from the default voice prosody; and decoding the speech vectors of the target voice prosody to produce output speech audio in the target voice prosody.

In some aspects, the techniques presented herein relate to a method, wherein converting comprises generating first speech vectors representing speech semantics and stationary attributes including volume, pitch modulation, and accents nuances associated with the default voice prosody.

In some aspects, the techniques presented herein relate to a method, wherein mapping comprises mapping the first speech vectors to second speech vectors for the target voice prosody.

In some aspects, the techniques presented herein relate to a method, wherein decoding is performed with an audio decoder that is part of a neural network audio codec system that includes an audio encoder and the audio decoder, which has been trained end-to-end with generative and adversarial loss functions of one or more deep neural network models, using clean speech audio distorted by artifacts and impairments.

In some aspects, the techniques presented herein relate to one or more non-transitory computer readable media encoded with instructions that, when executed by one or more processors, cause the one or more processors to perform operations including: obtaining speech audio to be encoded; applying the speech audio to an audio encoder that is part of a neural network audio codec system that includes the audio encoder and an audio decoder, wherein the audio encoder and the audio decoder have been trained in an end-to-end manner; encoding the speech audio with the audio encoder to generate embedding vectors that represent a snapshot of speech audio attributes over successive timeframes of the speech audio; and generating from the embedding vectors, codeword indices to entries in a codebook.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining speech audio to be encoded;
applying the speech audio to an audio encoder that is part of a neural network audio codec system that includes the audio encoder and an audio decoder, wherein the audio encoder and the audio decoder have been trained in an end-to-end manner;
encoding the speech audio with the audio encoder to generate embedding vectors that represent a snapshot of speech audio attributes over successive timeframes of the speech audio; and
generating from the embedding vectors, codeword indices to entries in a codebook.

2. The method of claim 1, encoding comprises encapsulating speech and background noise characteristics jointly or separately.

3. The method of claim 1, wherein the audio encoder is trained to encode degraded speech content into speech vectors by ignoring artifacts and impairments, and wherein encoding comprises producing speech embedding vectors that are more condensed compared to embedding vectors encompassing speech distorted by artifacts and impairments.

4. The method of claim 3, wherein encoding comprises generating speech embedding vectors representing speech semantics and stationary attributes including volume, pitch modulation, and accents nuances.

5. The method of claim 1, wherein the speech audio is to be converted to text, further comprising:
decoding the codeword indices associated with the embedding vectors to produce text for the speech audio.

6. The method of claim 1, wherein the speech audio contains speech in a first language and the codeword indices include a sequence of first codeword indices to the codebook for the first language, further comprising:
mapping the sequence of first codeword indices to a sequence of second codeword indices to a codebook for a second language; and
decoding the sequence of second codeword indices to produce an output audio stream of the speech audio in the second language.

7. The method of claim 1, wherein the speech audio contains speech of a first prosody and the codeword indices include a sequence of first codeword indices to the codebook for the first prosody, further comprising:
mapping the sequence of first codeword indices to a sequence of second codeword indices to a codebook for a second prosody; and
decoding the sequence of second codeword indices to produce an output audio stream of the speech audio in the second prosody.

8. The method of claim 1, further comprising:
converting the embedding vectors to language embeddings that are suitable to be provided as input to a large language model for a text generation task or for a discriminative task.

9. The method of claim 8, wherein converting is performed by a translator that has been trained across a broad spectrum of speaker profiles and content diversity to account for speech audio that results in embedding vectors of diverse sizes, to be invariant to speaker-specific variations, and to use one or more transformer models that account for different length sequences.

10. The method of claim 9, wherein the converting includes providing an end-of-sequence token to indicate that conversion for a sequence of indices is complete.

11. The method of claim 1, wherein encoding comprises encoding the speech audio at any bit rate within a rate range, in increments, based on use of a corresponding number of codeword indices included in an audio packet.

12. The method of claim 11, further comprising:
transmitting multiple audio packets within a network packet.

13. The method of claim 12, wherein transmitting comprises transmitting network packets, each network packet including a most recent audio packet in a sequence, the most recent audio packet encoded at a first bit rate R₀ and L plurality of previous audio packets in the sequence encoded at bit rates R₁, . . . , R_{L}, respectively, wherein rate R₀ is greater than bit rates R₁, . . . , R_{L}.

14. The method of claim 13, wherein bit rates R₁, . . . , R_{L} are each a second bit rate.

15. The method of claim 14, wherein the first bit rate is 6 kbps and the second bit rate is 1 kbps.

16. The method of claim 1, further comprising:
decoding, with the audio decoder, the codeword indices to recover the speech audio.

17. The method of claim 1, wherein the audio encoder and audio decoder have been trained with generative and adversarial loss functions of one or more deep neural network models in an end-to-end manner using clean speech audio distorted by artifacts and impairments.

18. An apparatus comprising:
one or more processors configured to execute instructions for an audio encoder to encode speech audio to generate embedding vectors that represent a snapshot of speech audio attributes over successive timeframes of the speech audio, and to generate from the embedding vectors, codeword indices to entries in a codebook; and
a communication interface configured to transmit a bit stream that includes the codeword indices.

19. The apparatus of claim 18, wherein the audio encoder is trained to encode degraded speech content into speech vectors by ignoring artifacts and impairments, and wherein the audio encoder generates speech embedding vectors that are more condensed compared to embedding vectors encompassing speech distorted by artifacts and impairments.

20. The apparatus of claim 18, wherein the audio encoder generates speech embedding vectors representing speech semantics and stationary attributes including volume, pitch modulation, and accents nuances.

21. The apparatus of claim 18, wherein the speech audio contains speech of a first prosody and the codeword indices include a sequence of first codeword indices to the codebook for the first prosody, wherein the one or more processors are configured to:
map the sequence of first codeword indices to a sequence of second codeword indices to a codebook for a second prosody.

22. A method comprising:
obtaining text to be converted to speech audio;
converting the text to speech vectors of a default voice prosody;
mapping the speech vectors of the default voice prosody to speech vectors of a target voice prosody that is different from the default voice prosody; and
decoding the speech vectors of the target voice prosody to produce output speech audio in the target voice prosody.

23. The method of claim 22, wherein converting comprises generating first speech vectors representing speech semantics and stationary attributes including volume, pitch modulation, and accents nuances associated with the default voice prosody.

24. The method of claim 23, wherein mapping comprises mapping the first speech vectors to second speech vectors for the target voice prosody.

25. The method of claim 23, wherein decoding is performed with an audio decoder that is part of a neural network audio codec system that includes an audio encoder and the audio decoder, which has been trained end-to-end with generative and adversarial loss functions of one or more deep neural network models, using clean speech audio distorted by artifacts and impairments.
